(19) United States
(12) Patent Application Publication
(10) Pub. No.: US 2026/0169918 A1
(43) Pub. Date: Jun. 18, 2026

(54) ATOMIC SEQUENCES USING MULTIPLE CACHE LINES

(71) Applicant: International Business Machines Corporation, Armonk, NY (US)

(72) Inventors: Yair FRIED, Petah Tiqwa (IL); Yossi SHAPIRA, TEL AVIV (IL); Gregory MIASKOVSKY, Ariel (IL); Aaron TSAI, Hyde Park, NY (US); Cedric LICHTENAU, Stuttgart (DE); Michael Joseph CADIGAN, JR., Poughkeepsie, NY (US); Jonathan Ting HSIEH, Poughkeepsie, NY (US); Timothy J. SLEGEL, Staatsburg, NY (US); Andrew H. TSANG, Poughkeepsie, NY (US); Erez BARAK, Hod Hasharon (IL)

(21) Appl. No.: 18/983,313

(22) Filed: Dec. 16, 2024

(51) Int. Cl. G06F 12/0804

(52) U.S. Cl. CPC G06F 12/0804; G06F 3/0619

(57) ABSTRACT

In some implementations, a storage device may receive from an application programming interface (API), a request to perform an atomic sequence for one or more cache lines associated with a set of stored data. The storage device may initiate the atomic sequence on the one or more cache lines. The storage device may monitor, during the atomic sequence, whether atomicity remains valid for the one or more cache lines. The storage device may provide, to the API, an indication of whether the one or more cache lines were updated in association with the request based at least in part on whether the atomicity remained valid.

### BACKGROUND

Atomic sequences in storage devices include sequences of operations that are designed to protect data integrity and reliability when performing tasks such as programming or erasing cells of a storage medium. For example, an atomic sequence may be used to modify a set of cache lines, where the whole set of cache lines are to be modified to avoid an error. In these sets of cache lines, modification of only some of the cache lines may lead to error because the set of cache lines are interdependent. Use of the term “atomic” is to signal that the entire atomic sequence is to be completed as a single, indivisible action. If interrupted (e.g., due to power loss, errors, or intervening actions by another device), the storage device may abort the atomic sequence, leaving the data in a pre-modified state rather than allowing only some of the sequence to be completed (e.g., only some of the cache lines to be modified).

### SUMMARY

In some implementations, a method comprises receiving from an application programming interface (API), a request to perform an atomic sequence for one or more cache lines associated with a set of stored data. The method includes initiating the atomic sequence on the one or more cache lines. The method includes monitoring, during the atomic sequence, whether atomicity remains valid for the one or more cache lines. The method further includes providing, to the API, an indication of whether the one or more cache lines were updated in association with the request based at least in part on whether the atomicity remained valid.

In some implementations, a computer program product comprises one or more computer readable storage media and program instructions collectively stored on the one or more computer readable storage media. The program instructions comprise program instructions to receive a request to perform an atomic sequence for one or more cache lines associated with a set of stored data. The program instructions comprise program instructions to initiate the atomic sequence on the one or more cache lines. The program instructions comprise program instructions to monitor, during the atomic sequence, whether atomicity remains valid for the one or more cache lines. The program instructions comprise program instructions to selectively complete the atomic sequence based at least in part on the atomicity remaining valid or abort the atomic sequence based at least in part on the atomicity failing to remain valid.

In some implementations, a system comprises one or more devices configured to receive a request to perform an atomic sequence for one or more cache lines associated with a set of stored data. The one or more devices are configured to read the one or more cache lines at a memory location of a storage device. The one or more devices are configured to modify the one or more cache lines to generate modified one or more cache lines. The one or more devices are configured to store the modified one or more cache lines in a store queue until all modifications are complete. The one or more devices are configured to monitor, during modification of the data, whether atomicity remains valid for the one or more cache lines. The one or more devices are configured to selectively write the modified one or more cache lines from the store queue back to the memory location based at least in part on the atomicity remaining valid or abort the atomic sequence based at least in part on the atomicity failing to remain valid.

### BRIEF DESCRIPTION OF THE DRAWINGS

FIGS. 1A-1E are diagrams of an example implementation described herein.

FIG. 2 is a diagram of an example implementation described herein.

FIG. 3 is a diagram of an example computing environment in which systems and/or methods described herein may be implemented.

FIG. 4 is a diagram of example components of one or more devices of FIGS. 1 and 2.

FIGS. 5-7 are flowcharts of example processes associated with atomic sequences using multiple cache lines.

### DETAILED DESCRIPTION

The following detailed description of example implementations refers to the accompanying drawings. The same reference numbers in different drawings may identify the same or similar elements.

The following provides an overview of some aspects of the present disclosure:

In some aspects, a method comprises receiving from an application programming interface (API), a request to perform an atomic sequence for one or more cache lines associated with a set of stored data. The method also includes initiating the atomic sequence on the one or more cache lines. The method additionally includes monitoring, during the atomic sequence, whether atomicity remains valid for the one or more cache lines. The method further includes providing, to the API, an indication of whether the one or more cache lines were updated in association with the request based at least in part on whether the atomicity remained valid. The method provides an improved solution for monitoring atomicity and performing atomic sequences. In this way, a computing device may conserve computing or power resources that may have otherwise been used to perform an atomic sequence without maintaining atomicity.

In some aspects, the method further comprises updating the one or more cache lines based at least in part on maintaining valid atomicity. In this way, a computing device may store an indication of whether atomicity is maintained and whether to drop the atomic sequence. The computing device may conserve resources that may have otherwise been used to continue or finish the atomic sequence that failed to maintain atomicity.

In some aspects, the method further comprises refraining from updating the one or more cache lines based at least in part on failing to maintain valid atomicity. In this way, the computing device may conserve resources that may have otherwise been used to finish the atomic sequence that failed to maintain atomicity (e.g., storing the cache lines back into memory even though atomicity was not maintained). Further the computing device may conserve resources that may have otherwise been used to correct or replace the cache lines that were erroneously written back to memory when atomicity was not maintained.

In some aspects, the method further comprises providing an indication of whether atomicity remains valid within an entry of a store queue associated with a write operation of the atomic sequence. For example, the computing device may indicate whether cache lines maintained atomicity when they are moved to the store queue in preparation for writing back to the memory. In this way, the computing device may have an indication of whether to drop the atomic sequence and conserve resources that may have otherwise been used to continue or finish the atomic sequence that failed to maintain atomicity.

In some aspects, the atomic sequence comprise reading data at a memory location of a storage device, modifying the data to generate modified data, and writing back the modified data to the memory location without another device reading or modifying the memory location after the reading of the data at the memory location. In this way, the computing device may make a change to a set of cache lines in a way that protects atomicity such that one or more cache lines are not modified separately from the atomic sequence (e.g., by another API or device), which may conserve computing or power resources that may have otherwise been used to detect and correct errors associated with failing to modify the set of cache lines as a single modification operation.

In some aspects, the method may further comprise storing cache lines of the modified data in a store queue, and refraining from writing back the modified data to the memory location until all of the cache lines of the modified data are stored in the store queue. In this way, the computing device may refrain from writing back any cache lines (e.g., even those indicated as maintaining atomicity) until all of the cache lines of the atomic sequence are ready to write back to the memory with maintained atomicity. The computing device may conserve resources that may have otherwise been used to correct or replace the cache lines that were erroneously written back to memory when atomicity was not maintained for all of the cache lines.

In some aspects, writing back the modified data to the memory location comprises writing back the modified data based at least in part on all of the cache lines of the modified data being stored in the store queue, atomicity remaining valid at a time of writing back the modified data, and none of the cache lines of the modified data being associated with an indication to abort the atomic sequence. In this way, the computing device may conserve resources that may have otherwise been used to correct or replace the cache lines that were erroneously written back to memory when atomicity was not maintained for all of the cache lines.

In some aspects, the method further comprises storing information associated with the one or more cache lines and the atomic sequence in a hardware structure configured for monitoring atomic cache lines. In this way, the computing device (e.g., at the storage device) may include a hardware component that is used to monitor and store a status of atomicity in a way that is maintained throughout the atomic sequence. This may reduce errors in performing atomic sequences, which may conserve computing and power resources that may have otherwise been used to detect and correct errors associated with continuing or completing an atomic sequence (e.g., the writing back to memory) when atomicity is not maintained.

In some aspects, the information comprises one or more of an indication of validity of a cache line of the one or more cache lines, an address of the cache line, or an indication, associated with the cache line, of whether to abort the atomic sequence. In this way, the computing device may check to determine whether to continue, complete, or drop an atomic sequence, which may conserve computing and power resources that may have otherwise been used to erroneously write back the cache lines to the memory when atomicity was not maintained, and then to detect and correct the error.

In some aspects, the information comprises atomic monitoring cache lines for respective cache lines of the one or more cache lines. In this way, the computing device may store the indications of atomicity or an abort indication in an organized data structure. This may improve accuracy in detection of violations of atomicity, which may conserve computing and power resources that may have otherwise been used to erroneously write back the cache lines when atomicity was not maintained, and to detect and correct errors caused by the error.

In some aspects, a computer program product includes one or more computer readable storage media, and program instructions collectively stored on the one or more computer readable storage media. The program instructions comprise program instructions to receive a request to perform an atomic sequence for one or more cache lines associated with a set of stored data. The program instructions comprise program instructions to initiate the atomic sequence on the one or more cache lines. The program instructions comprise program instructions to monitor, during the atomic sequence, whether atomicity remains valid for the one or more cache lines. The program instructions further comprise program instructions to selectively complete the atomic sequence based at least in part on the atomicity remaining valid or abort the atomic sequence based at least in part on the atomicity failing to remain valid. In this way, a computing device may conserve computing or power resources that may have otherwise been used to perform an atomic sequence without maintaining atomicity.

In some aspects, completing the atomic sequence comprises modifying the one or more cache lines and writing back to storage the one or more cache lines after being modified. In this way, the computing device may make a change to a set of cache lines in a way that protects atomicity such that one or more cache lines are not modified separately from the atomic sequence (e.g., by another API or device), which may conserve computing or power resources that may have otherwise been used to detect and correct errors associated with failing to modify the set of cache lines as a single modification operation.

In some aspects, the program instructions include program instructions to provide an indication of whether the one or more cache lines were updated in association with the request. In this way, an API associated with the request to perform the atomic sequence is informed about whether the atomic sequence was successful or whether the API is to send another request to perform the atomic sequence.

In some aspects, the program instructions comprise program instructions to provide an indication of whether atomicity remains valid within an entry of a store queue associated with a write operation of the atomic sequence. In this way, the computing device may have an indication of whether to drop the atomic sequence and conserve resources that may have otherwise been used to continue or finish the atomic sequence that failed to maintain atomicity.

In some aspects, the program instructions comprise program instructions to store information associated with the one or more cache lines and the atomic sequence in a hardware structure configured for monitoring atomic cache lines. In this way, the computing device (e.g., at the storage device) may include a hardware component that is used to monitor and store a status of atomicity in a way that is maintained throughout the atomic sequence. This may reduce errors in performing atomic sequences, which may conserve computing and power resources that may have otherwise been used to detect and correct errors associated with continuing or completing an atomic sequence (e.g., the writing back to memory) when atomicity is not maintained.

In some aspects, the information comprises one or more of an indication of validity of a cache line of the one or more cache lines, an address of the cache line, or an indication, associated with the cache line, of whether to abort the atomic sequence. In this way, the computing device may check to determine whether to continue, complete, or drop an atomic sequence, which may conserve computing and power resources that may have otherwise been used to erroneously write back the cache lines to the memory when atomicity was not maintained, and then to detect and correct the error.

In some aspects, the information comprises atomic monitoring cache lines for respective cache lines of the one or more cache lines. In this way, the computing device may store the indications of atomicity or an abort indication in an organized data structure. This may improve accuracy in detection of violations of atomicity, which may conserve computing and power resources that may have otherwise been used to erroneously write back the cache lines when atomicity was not maintained, and to detect and correct errors caused by the error.

In some aspects, a system comprises one or more devices configured to receive a request to perform an atomic sequence for one or more cache lines associated with a set of stored data. The one or more devices are configured to read the one or more cache lines at a memory location of a storage device. The one or more devices are configured to modify the one or more cache lines to generate modified one or more cache lines. The one or more devices are configured to store the modified one or more cache lines in a store queue until all modifications are complete. The one or more devices are configured to monitor, during modification of the data, whether atomicity remains valid for the one or more cache lines. The one or more devices are configured to selectively write the modified one or more cache lines from the store queue back to the memory location based at least in part on the atomicity remaining valid, or abort the atomic sequence based at least in part on the atomicity failing to remain valid. In this way, a computing device may conserve computing or power resources that may have otherwise been used to perform an atomic sequence without maintaining atomicity.

In some aspects, writing of the modified one or more cache lines from the store to the memory location is further based at least in part on none of the updated one or more cache lines being associated with an indication to abort the atomic sequence. In some aspects, aborting of the atomic sequence is further based at least in part on at least one of the updated one or more cache lines being associated with an indication to abort the atomic sequence. In this way, the computing device may conserve resources that may have otherwise been used to correct or replace the cache lines that were erroneously written back to memory when atomicity was not maintained for all of the cache lines.

In some aspects, the one or more devices are configured to store, within a hardware structure configured for monitoring atomic cache lines, one or more of: an indication of validity of a cache line of the one or more cache lines, an address of the cache line, or an indication, associated with the cache line, of whether to abort the atomic sequence. In this way, the computing device may check to determine whether to continue, complete, or drop an atomic sequence, which may conserve computing and power resources that may have otherwise been used to erroneously write back the cache lines to the memory when atomicity was not maintained, and then to detect and correct the error.

In some situations, a computing device may perform an atomic sequence to fetch, modify, and store operations on a storage device (e.g., a storage medium of the storage device). For example, a code sequence may cause the storage device to read data (e.g., one or more cache lines) from a location of memory (e.g., a storage medium), modify the data, and write the data back to the memory. If the code sequence is associated with an atomic sequence, the writing back may be permitted only if no other central processing unit (CPU) or thread has read or modified the storage medium at the location of the memory between the time of reading the data and writing the data back to the memory.

However, when multiple cache lines are used in the atomic sequence, the storage device may not support tracking atomicity of other cache lines when deciding whether to write back a cache line to the memory.

When any load or store instruction is issued, the CPU may hold instruction information, including cache line locations, in a load queue or in a store queue, respectively. The load queue may include entries that are valid only until a load instruction completes, which is a short-term storage time. After the load queue expires or is erased, any indication of atomicity may be lost until a cache line enters the store queue.

In some aspects described herein, a storage device may include a structure (e.g., in hardware) for monitoring atomic cache lines (e.g., an atomic cache line monitor (ACLM)). In some aspects, the storage device may save a specified number of cache lines in the ACLM. ACLM entries may include a “valid” indicator (bit), “abort” indicator (bit), or a cache line location field. In some aspects, the storage device may include e multiple ACLM structures to support multiple cache lines.

In some aspects, software may use special load and store instructions. For example, an instruction to decode may be tagged as part of an atomic sequence. An instruction to decode may be used to indicate an associated ACLM. The last special load or store in the sequence may be tagged as the last to indicate that the atomic sequence is complete. In some aspects, the software may reset all the ACLMs (e.g., entries of one or more ACLMs) before an atomic sequence begins.

In addition to the structure for monitoring atomic cache lines, the storage device may add an “is atomic” indicator (e.g., a single bit) for each entry in an associated store queue.

The storage device may perform an atomic sequence beginning with resetting ACLMs (e.g., entries in the ACLM). Special load or store operations (e.g., special based at least in part on being tagged as atomic) that issued successfully (e.g., no rejected or rescinded) may have a “valid” indication set and indicate a cache line location for an associated ACLM. For store instructions, the “is atomic” indication in the store queue may also be set. When a subsequent store instruction to be processed out of the store queue has “is atomic” set, the store queue may be stalled, and store processing is stopped. In this way, the store queue holds data for writing back to the memory (e.g., until all cache lines associated with the atomic sequence are received at the store queue in a valid and not aborted state).

If a cache line that is valid in any of the ACLMs is taken out of an L1 cache (e.g., cross interrogation (XI) or least recently used (LRU) because another line may use the memory), then an “abort” indicator (e.g., bit) may be set (e.g., to indicate that atomicity is broken).

When the last atomic instruction completes, the store queue stall is lifted and stores are allowed to be processed out of the store queue. If any of the ACLMs has the “abort” indicator set, then all the stores that has “is atomic” bit indication are dropped from the store queue. Otherwise, the storage device may clear the “is atomic” bits from all the entries, and let the stores be processed out of the STQ for writing back to the storage medium. The storage device may report back to the software (e.g., an application programming interface (API)) if the sequence was successful or aborted.

Based at least in part on using monitoring whether atomicity remains valid during the atomic sequence for multiple cache lines, the storage device may successfully maintain atomicity for the atomic sequence for the multiple cache lines, or may abandon the atomic sequence if any of the cache lines fail to maintain atomicity. In this way, the storage device may reduce errors that may otherwise be caused by modifying only some of the multiple cache lines, which reduction of errors may conserve computing and power resources that may otherwise have been consumed to detect the errors, correct the errors through recovery, or receive again the data associated with the cache lines from an outside source.

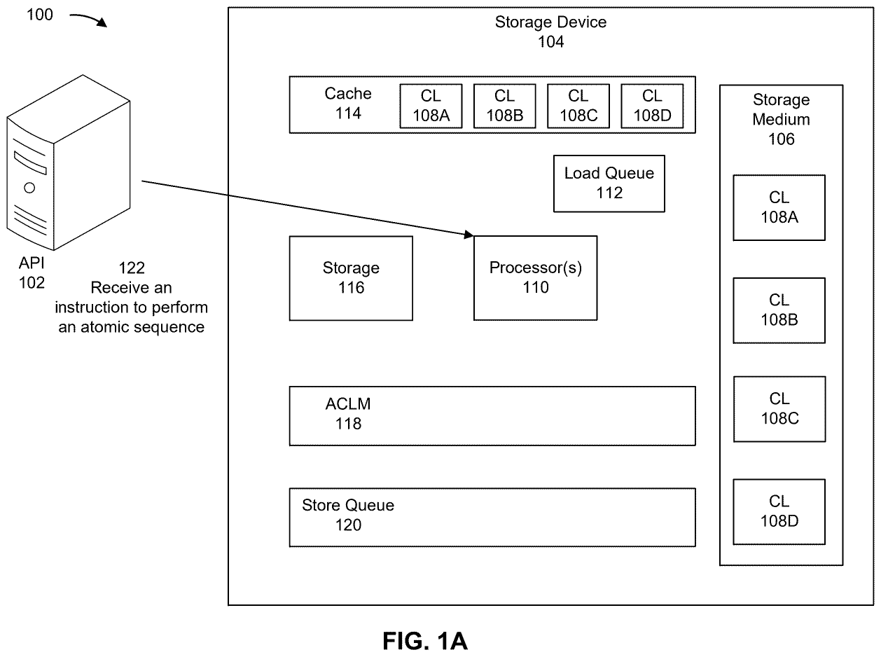

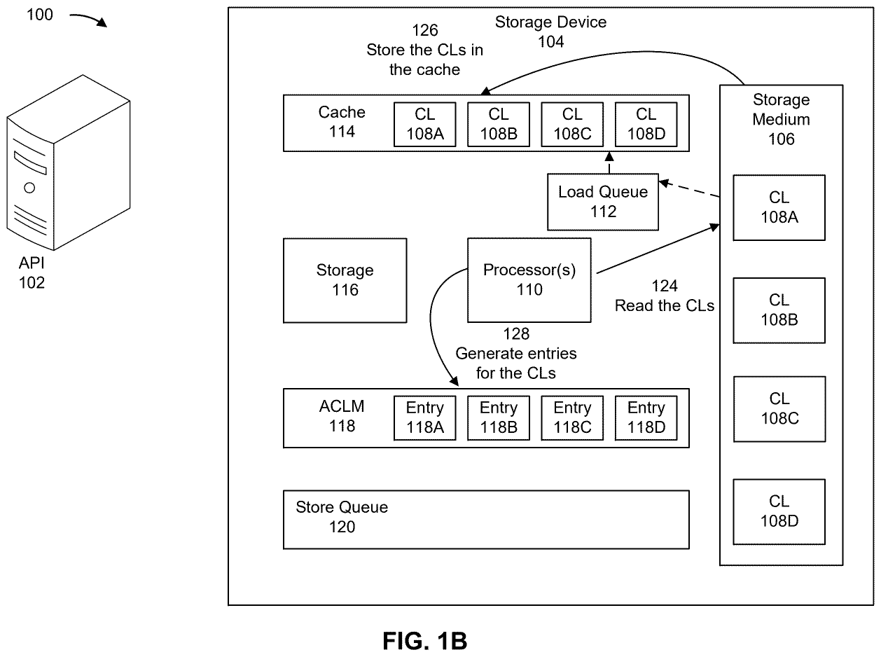

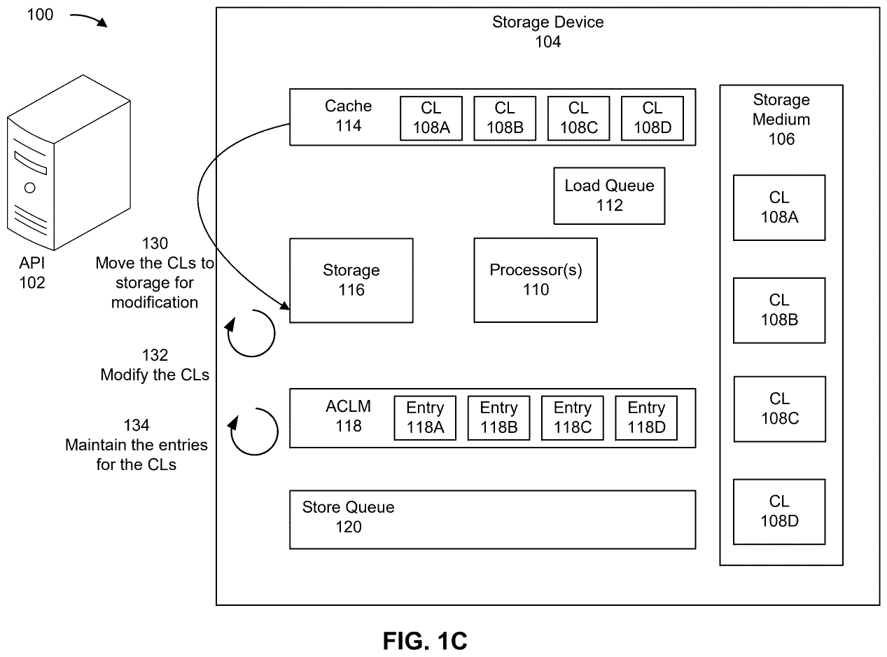

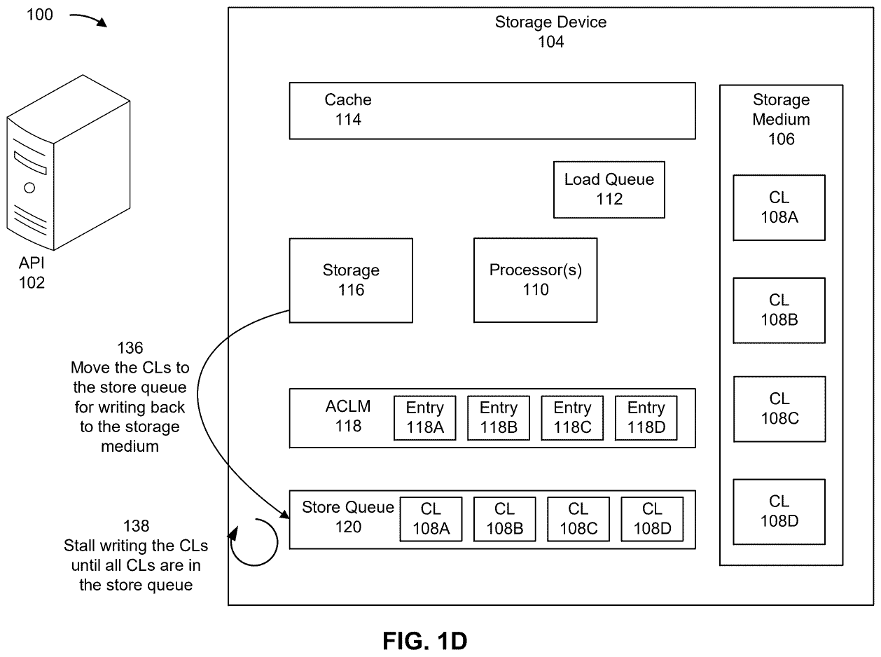

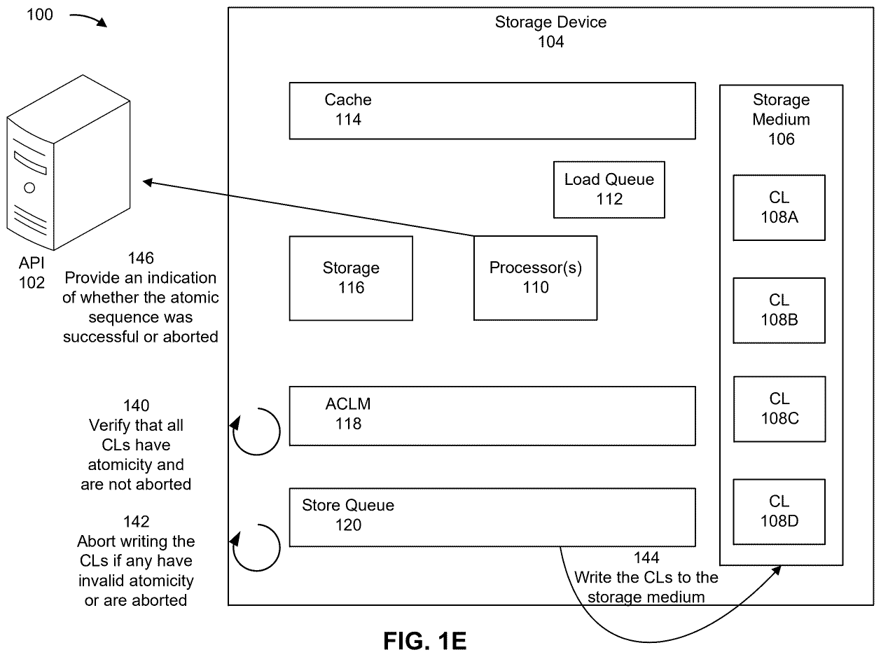

FIGS. 1A-1E are diagrams of an example implementation 100 described herein. As shown in FIGS. 1A-1E, example implementation 100 includes an API 102 (e.g., an application or CPU) and a storage device 104. The storage device 104 may include a storage medium 106 (one or more storage media), cache lines (CLs) 108A-108D stored on the storage medium 106 (the cache lines may be stored as data in any format on the storage medium 106, such as word lines, virtual word lines, pages, or in other structures), one or more processors 110, a load queue 112, a cache 114, storage 116 (e.g., a dynamic random access memory (DRAM)) that is external to the storage medium 106, an ACLM 118, and a store queue 120. Although operations may be shown as being performed by one or more of the components 112-120, the one or more processors 110 may assist in performing the operations. For example, the one or more processors 110 may provide instructions or commands to one or more of the components. Additionally, or alternatively, one or more components shown in FIGS. 1A-1E may be combined with other components as a single component, may be omitted from a storage device 104, or may include multiple devices.

As shown in FIG. 1A, and by reference number 122, the storage device 104 may receive an instruction (e.g., a command or request) to perform an atomic sequence. For example, the API 102 may provide a request to modify a set of data that is spread across multiple cache lines 108A-108D where the set of data includes interdependent components. In some aspects, the instructions may include receiving a host logical address associated with the set of data that corresponds to a physical location of the data (e.g., as word lines or another structure) within the storage medium 106. The one or more processors 110 may use one or more operations to convert the instructions into additional instructions that can be provided to the storage medium 106 to identify the cache lines 108A-108D as the set of data (e.g., using a host logical address to a local address including, for example, a local logical address or a physical address).

In some aspects, the set of data may include a list of elements that are linked to each other (e.g., with each component pointing to a subsequent component) and an indication of a number of elements of the list. In some aspects, modifying a first element of the list may break a link to a second element (subsequent element) if the second element is modified without coordination with the modification of the first element. Similarly, if a third element is added to the list between the first element and the second element without coordination, the first element may be modified to link to the third element and the third element may be written to link to the second element (changing from a 1-2 link to a 1-3-2 link). However, if another device (CPU or API) also attempts to modify the first element to point to a fourth element (e.g., a new element or the third element in a different location than in the first adding of the third element), the links between the elements may be broken. Additionally, if the third element is added, but another device modifies the count of elements in the set, the count may be erroneous after modification.

As shown in FIG. 1B, and by reference number 124, the one or more processors 110 may perform a read operation to read the cache lines 108A-108D. As shown by reference number 126, the storage device 104 may store the cache lines 108A-108D in the cache 114. In some aspects, the one or more processors 110 may involve the load queue 112 to load the cache lines 108A-108D into the cache 114. In some aspects, the load queue 112 may track instructions that access the cache lines.

In some aspects, the load queue may include a hardware structure that manages load instructions (e.g., read operations). The load queue may support correctness, efficiency, and improved performance in system where read operations are complex based at least in part on out-of-order execution, caching, or memory dependency, among other examples. In some aspects, the load queue may keep track of load instructions that have been issued but not completed (e.g., only part of the data has been fetched from the storage medium).

As shown by reference number 128 the one or more processors 110 (e.g., a controller or other CPU) may generate entries 116A-116D for the cache lines in the ACLM 118. In some aspects, the one or more processors 110 may generate the entries 116A-116D for the cache lines based at least in part on receiving the instruction to perform the atomic sequence, reading the cache lines, or storing the cache lines in the cache 114. In other examples, the one or more processors may generate the entries 116A-116D for the cache lines in the ACLM 118 based at least in part on a later operation (e.g., operation 130).

In some aspects, the entries 116A-116D may include information associated with the cache lines 108A-108D. For example, the information may include an indication of whether atomicity of a cache line is valid, an address of the cache line within the storage medium 106, or whether the storage device 104 is to abort the atomic sequence based at least in part on a condition for the cache line (e.g., a cache line is taken out of a layer 1 cache). In some aspects, the entries may be cache lines of the ACLM 118.

As shown in FIG. 1C, and by reference number 130, storage device 104 may move the cache lines 108A-108D to a storage 116 (e.g., a storage device) for modification. In some aspects, the storage 116 may include a volatile memory, such as a DDR RAM or DRAM that is internal to the storage device 104 or external to the storage device 104. In some aspects, the storage 116 may be included in, or may include, a same component as the cache 114. In some aspects, operation 130 may be omitted and the cache 114 and storage 116 may be a same component such that movement of cache lines to storage for modification is not included in a process associated with FIGS. 1A-1E.

In some aspects, the one or more processors 110 may cause the cache lines 108A-108D to be moved to the storage 116. In some aspects, the cache lines 108A-108D may be moved via one or more additional components of the storage device 104 or other location where the cache lines can be modified by the storage device 104, the API 102, or another CPU.

As shown by reference number 132, the cache lines 108A-108D may be modified while in the storage 116 (or other location, as described above). In some aspects, the one or more processors 110 may cause the modification of the cache lines 18A-108D by providing instructions for the modification. For example, the cache lines 108A-108D may be modified to change one or more values within, add one or more values to, or delete one or more values from, the cache lines 108A-108D.

As shown by reference number 134, the ACLM 118 may maintain the entries for the cache lines. For example, the ACLM 118 may monitor for any changes to the atomicity of cache lines 108A-108D associated with entries stored thereon or whether any of the cache lines 108A-108D associated with the entries are to be aborted. In some aspects, the ACLM 118 may monitor for any changes based at least in part on receiving information (e.g., from the one or more processors 110) associated with any read or write requests issued to the storage device 104 that are associated with locations of the storage medium 106 that match any of the entries 116A-116D (e.g., associated with cache lines 108A-108D). The ACLM 118 may continue to maintain the entries 116A-116D until corresponding cache lines 108A-108D are written back to the storage medium 106 or are aborted (e.g., based at least in part on an indication to abort or an indication that atomicity is not valid).

As shown in FIG. 1D, and by reference number 136, the storage 116 may move the cache lines to the store queue 120 for writing back to the storage medium 106. In some aspects, the storage 116 may move the cache lines to the store queue 120 based at least in part on a command or instruction from the one or more processors 110. Additionally, or alternatively, the cache lines may move to the store queue 120 via one or more additional components of the storage device 104. In some aspects, the store queue 120 may receive the cache lines at different times (e.g., one at a time after modification or in groups).

When delivered to the store queue 120, the cache lines 108A-108D are modified cache lines 108A-108D. In some aspects, the store queue 120 may provide an indication of atomicity of the cache lines while in the store queue 120. For example, when a cache line is delivered to the store queue 120 as part of an atomic sequence, if the cache line has maintained atomicity through the atomic sequence, the cache line may be marked with an “is atomic” indication (e.g., bit) by the store queue 120, the ACLM 118, or the one or more processors 110, among other examples.

As shown by reference number 138, the store queue 120 may stall writing the cache lines to the storage medium 106 until all cache lines are in the store queue 120. In some aspects, the store queue 120 may stall writing a cache line based at least in part on an indication that atomicity is valid for the cache line, and a full set of related cache lines is not yet in the store queue 120. In some aspects, the store queue 120 may stall writing the cache lines based at least in part on an instruction from the one or more processors 110, the ACLM 118, or another component.

As shown in FIG. 1E, and by reference number 140, the ACLM 118 may verify that all cache lines have atomicity and are not aborted. In some aspects, the one or more processors or the store queue may verify that all cache lines have atomicity and are not aborted based at least in part on accessing the entries 116A-116D at the ACLM 118.

As shown by reference number 142, the store queue 120 may abort writing the cache lines if any have invalid atomicity or have been determined to be aborted. For example, if any of the entries 116A-116D has an “abort” indication set, all cache lines at the store queue 120 may be dropped from the store queue 120 based at least in part on having a broken atomicity.

As shown by reference number 144, the store queue 120 may write the cache lines to the storage medium 106. For example, if none of the cache lines 108A-108D in the store queue 120 have been marked with an “abort” indication, the store queue 120 may write the cache lines 108A-108D to the storage medium 106 (e.g., as modified cache lines). In some aspects, the store queue 120 may remove any “abort” indications (positive or negative indications) from the cache lines 108A-108D before writing the cache lines 108A-108D to the storage medium 106 as modified cache lines. In this way, a bit that indicates whether to abort the atomic sequence is not written back to the storage medium 106.

In an example, a core (e.g., CPU) may provide an instruction to add an element at the beginning of a queue (e.g., with each element pointing to the next element). In the queue, H (for head) is the address of the first element on the queue. C (for count) is a count of the number of elements on the queue. F (for forward) is a variable contained in respective queue elements that indicates an address of the next element on the queue. If a new element N is to be enqueued at the head of the queue, the storage device may perform operations as described above.

For example, the storage device may perform a fetch operation where the storage device fetches a value of H (e.g., in one or more cache lines), which includes an address of the first element of the queue before modification. The storage device may store H into N. F to change H to point to the new first element N, with the new first element pointing to the previous first element (e.g., before modification. The storage device may store address N into H (so that H now points to the new first element N. The storage device may fetch C (the number of elements in the queue before modification) and may write back a value of C+1 in place of C (to indicate that the number of elements in the queue has increased by 1 because of the addition of N). These operation are to be done atomically to prevent other cores from writing on the same information, which could cause errors in the queue. Additionally, no other adjustments are allowed if the cache lines associated with the queue are used in the atomic process.

Using the ACLM 118 to monitor atomicity, the storage device 104 may fetch an atomic H (e.g., using software). The storage device 104 may use a first cache line of the ACLM 118 (ACLM0) to store information associated with a first cache line of the queue. For example, ACLM0 may store ACLM0.valid=1, ACLM0.CL=address(H), ACLM0.abort=0.

The storage device 104 (e.g., using software) may store atomic H into N. F (using ACLM1). ACLM1 (hardware) may include ACLM1.valid=1, ACLM1.CL=address(N. F), ACLM1.abort=0. In some aspects, the store queue 120 (hardware) may also store information associated with the atomic H. For example, the store queue 120 may store [store(N. F)]. atomic =1. The store may be stalled in the store queue 120 and not yet written to a layer 1 cache.

The storage device 104 (e.g., using software) may store an atomic address N into H (possibly reusing ACLM0 since the value H has already been sent to the store queue 120). The ACLM 118 may store ACLM0.valid=1, ACLM0.CL=address(H), ACLM0.abort=0. The store queue 120 may store [store(H)]. atomic =1. The store may be stalled in the store queue 120 and not yet written to layer 1 cache (e.g., because not all cache lines associated with the atomic sequence is in the store queue 120).

The storage device 104 (e.g., using software) may fetch C and associate the cache line of C with ACLM2. ACLM 118 may store ACLM2.valid=1, ACLM2.CL=address(C), ACLM2.abort=0. The storage device 104 (e.g., using software) may store an atomic last C+1 into C and the ACLM 118 may reuse ACLM2. The ACLM 118 may store ACLM2.valid=1, ACLM2.CL=address(C), ACLM2.abort=0. The store queue 120 may store [store(C)]. atomic=1. The store may be stalled in the store queue 120 and not yet written to layer 1 cache (e.g., because still not all cache lines associated with the atomic sequence is in the store queue 120 and the store queue 120 may need to check for any abort indications with H or other cache lines).

If after the final atomic operation all ACLMx.abort=0, then the entire sequence was done atomically and set STQ[N/H.F/C].atomic=0 and store queue 120 data can now be written into layer 1 cache. If after the final atomic operation any of the ACLMx.abort=1, then the sequence was not done atomically and therefore the store queue 120 is to drop STQ[N/H.F/C] data and refrain from writing the cache lines into layer 1 cache.

As indicated above, FIGS. 1A-1E are provided as an example. Other examples may differ from what is described with regard to FIGS. 1A-1E. The number and arrangement of devices shown in FIGS. 1A-1E are provided as an example.

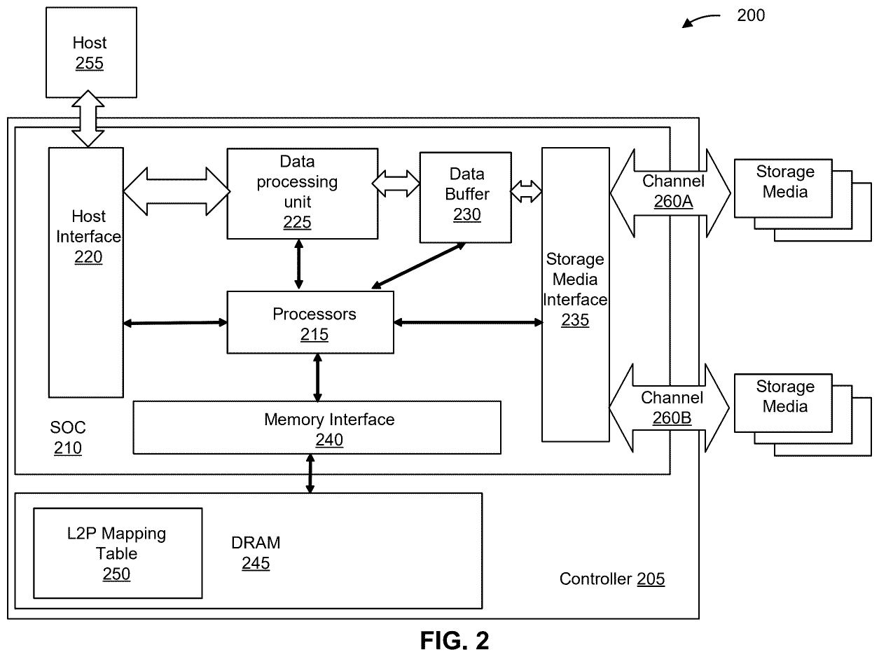

FIG. 2 is a diagram of example components of a storage device 200, which may correspond to one or more devices or components of FIG. 1.

As shown in FIG. 2, the storage device 200 may include a controller 205 (e.g., an SSD controller). The controller 205 may include a system on chip (SOC) 210. The SOC 210 may perform computing or processing operations for the controller 205. The SOC 210 may include one or more processors 215 that control, command, or observe operations at one or more other components of the SOC 210. The one or more processors 215 may be communicably coupled to one or more of a host interface 420, a data processing unit (DPU) 225, a data buffer 230, a storage medium interface 235, or a memory interface 240.

The host interface 210 may be configured to communicate with a host device (e.g., host device 255 described below). The DPU 225 may manage data flow between the host interface 210 and storage media. The DPU 225 may further include a functional block that is responsible for managing data operations, such as reading, writing, error correction, or formatting. The DPU 225 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 230 is a pipeline data buffer for the data transition. The data buffer 230 may include a temporary storage area used to transfer or process data between the storage media and a host system. The memory interface 240 is an interface between controller 210 and external DDR or DRAM, which may be used to temporarily hold the data. The memory interface 240 may provide an interface between the SOC 210 and the DRAM 245 to facilitate transfers of information. For example, the memory interface 240 may support requests to access a logical to physical (L2P) mapping table to identify a physical location of data requested by the host device, or to provide mapping information for storage in the L2P mapping table.

The controller 205 may further include DRAM 245. The DRAM 245 may locally store information that is available on demand at the controller 205 for operations of the controller 205. For example, the DRAM 245 may store an L2P mapping table 250 that maps logical locations of data and physical locations of data on connected storage media. In this way, the controller 205 may have access to mapping information for locating data on the connected storage media based at least in part on an indication associated with host data when written.

The host interface 220 may provide an interface for communicating with a host 255. For example, the host interface 220 may receive an access request or data for storage on connected storage media. In some aspects, the host interface 220 may provide data to the host after reading the data on from the connected storage media.

The storage media interface 235 may communicate via one or more channels 260 (e.g., 260A and 260B) with one or more connected storage media 265 (e.g., 265A and 265B). For example, the controller 205 may perform or initiate a read or write operation at a physical location of a storage media device 265.

As indicated above, FIG. 2 is provided as an example. Other examples may differ from what is described with regard to FIG. 2. The number and arrangement of devices shown in FIG. 2 are provided as an example.

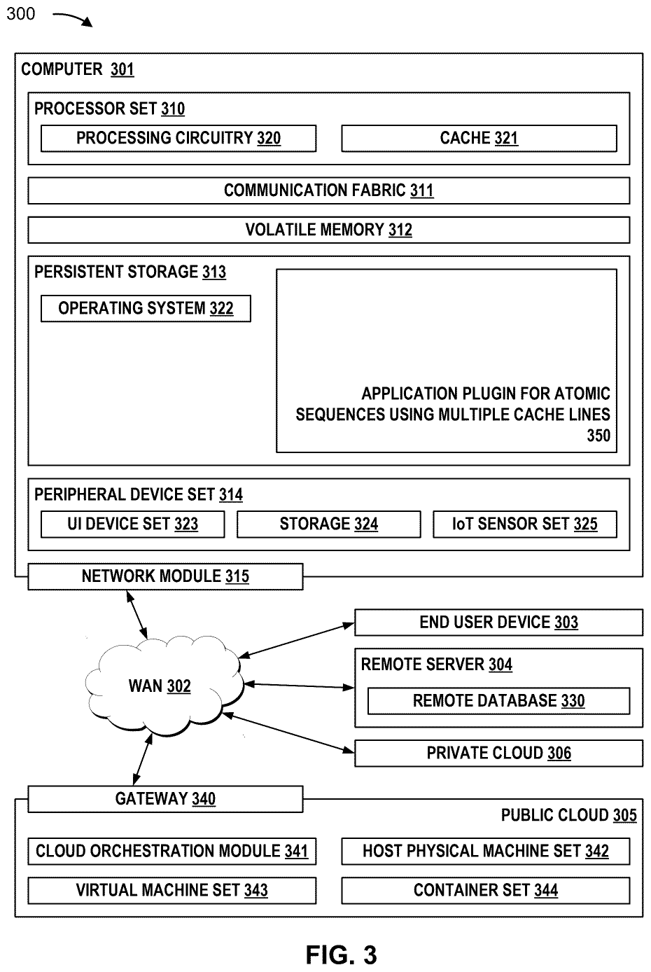

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application plugin for atomic sequences using multiple cache lines 350. In addition to application plugin for atomic sequences using multiple cache lines 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for atomic sequences using multiple cache lines 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for atomic sequences using multiple cache lines 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for atomic sequences using multiple cache lines 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

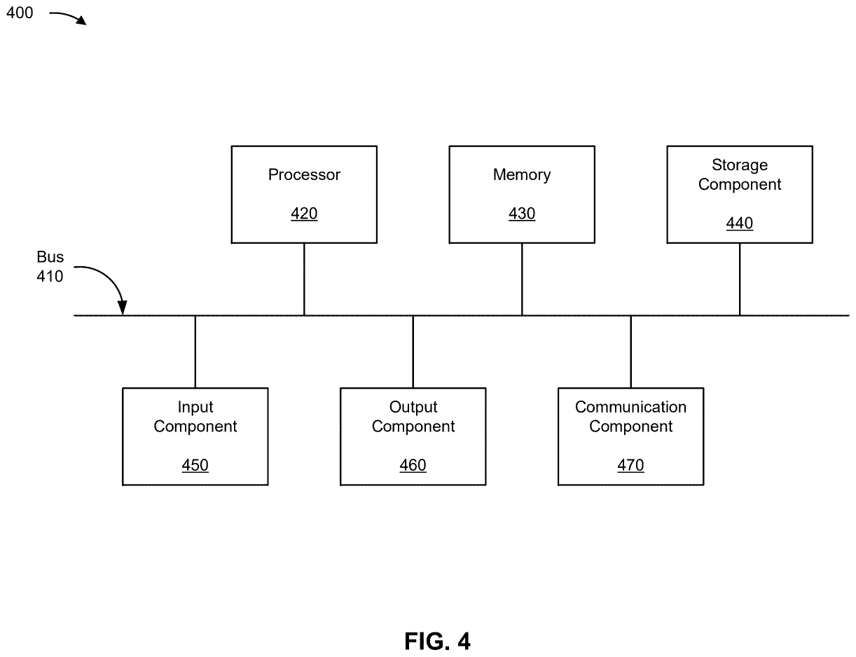

FIG. 4 is a diagram of example components of a device 400, which may correspond to the storage device 104 or the SOC 210. In some implementations, the storage device 104 or the SOC 210 may be included in, or may include, one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

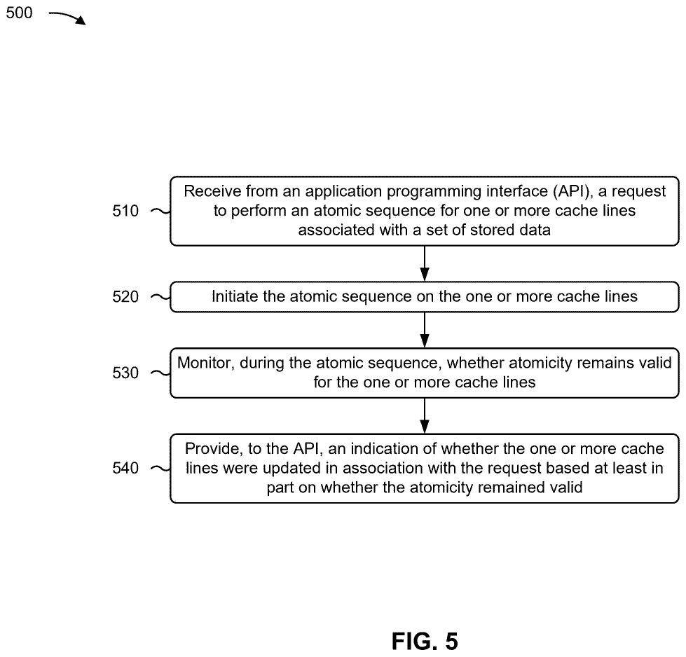

FIG. 5 is a flowchart of an example process 500 associated with atomic sequences using multiple cache lines. In some implementations, one or more process blocks of FIG. 5 may be performed by a storage device (e.g., storage device 104). In some implementations, one or more process blocks of FIG. 5 may be performed by another device or a group of devices separate from or including the storage device. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving from an application programming interface (API), a request to perform an atomic sequence for one or more cache lines associated with a set of stored data (block 510). For example, the storage device may receive from an application programming interface (API), a request to perform an atomic sequence for one or more cache lines associated with a set of stored data, as described above.

As further shown in FIG. 5, process 500 may include initiating the atomic sequence on the one or more cache lines (block 520). For example, the storage device may initiate the atomic sequence on the one or more cache lines, as described above.

As further shown in FIG. 5, process 500 may include monitoring, during the atomic sequence, whether atomicity remains valid for the one or more cache lines (block 530). For example, the storage device may monitor, during the atomic sequence, whether atomicity remains valid for the one or more cache lines, as described above.

As further shown in FIG. 5, process 500 may include providing, to the API, an indication of whether the one or more cache lines were updated in association with the request based at least in part on whether the atomicity remained valid (block 540). For example, the storage device may provide, to the API, an indication of whether the one or more cache lines were updated in association with the request based at least in part on whether the atomicity remained valid, as described above.

Process 500 may include additional implementations, such as any single implementation or any combination of implementations described below and/or in connection with one or more other processes described elsewhere herein.

In a first implementation, process 500 includes updating the one or more cache lines based at least in part on maintaining valid atomicity.

In a second implementation, alone or in combination with the first implementation, process 500 includes refraining from updating the one or more cache lines based at least in part on failing to maintain valid atomicity.

In a third implementation, alone or in combination with one or more of the first and second implementations, process 500 includes providing an indication of whether atomicity remains valid within an entry of a store queue associated with a write operation of the atomic sequence.

In a fourth implementation, alone or in combination with one or more of the first through third implementations, the atomic sequence comprises reading data at a memory location of a storage device, modifying the data to generate modified data, and writing back the modified data to the memory location without another device reading or modifying the memory location after the reading of the data at the memory location.

In a fifth implementation, alone or in combination with one or more of the first through fourth implementations, process 500 includes storing cache lines of the modified data in a store queue, and refraining from writing back the modified data to the memory location until all of the cache lines of the modified data are stored in the store queue.

In a sixth implementation, alone or in combination with one or more of the first through fifth implementations, writing back the modified data to the memory location comprises writing back the modified data based at least in part on all of the cache lines of the modified data being stored in the store queue, atomicity remaining valid at a time of writing back the modified data, and none of the cache lines of the modified data being associated with an indication to abort the atomic sequence.

In a seventh implementation, alone or in combination with one or more of the first through sixth implementations, process 500 includes storing information associated with the one or more cache lines and the atomic sequence in a hardware structure configured for monitoring atomic cache lines.

In an eighth implementation, alone or in combination with one or more of the first through seventh implementations, the information comprises one or more of an indication of validity of a cache line of the one or more cache lines, an address of the cache line, or an indication, associated with the cache line, of whether to abort the atomic sequence.

In a ninth implementation, alone or in combination with one or more of the first through eighth implementations, the information comprises atomic monitoring cache lines for respective cache lines of the one or more cache lines.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

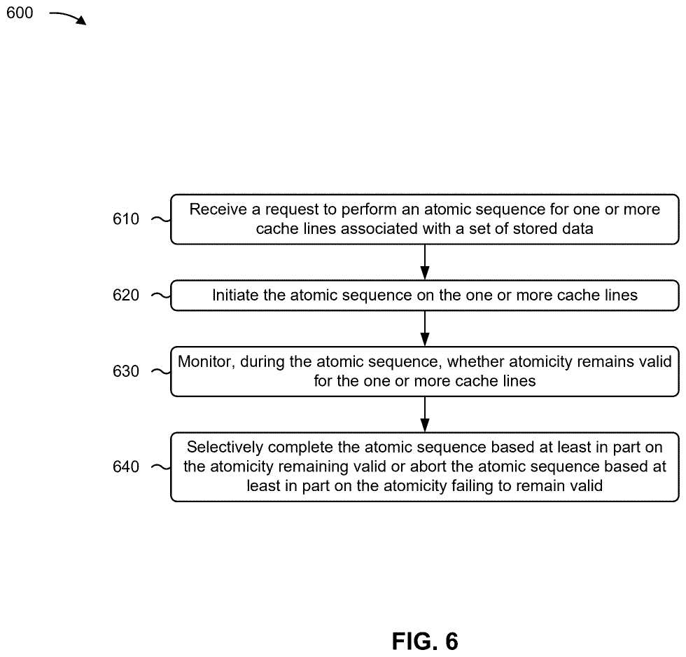

FIG. 6 is a flowchart of an example process 600 associated with atomic sequences using multiple cache lines. In some implementations, one or more process blocks of FIG. 6 may be performed by a storage device (e.g., storage device 104). In some implementations, one or more process blocks of FIG. 6 may be performed by another device or a group of devices separate from or including the storage device. Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include receiving a request to perform an atomic sequence for one or more cache lines associated with a set of stored data (block 610). For example, the storage device may receive a request to perform an atomic sequence for one or more cache lines associated with a set of stored data, as described above.

As further shown in FIG. 6, process 600 may include initiating the atomic sequence on the one or more cache lines (block 620). For example, the storage device may initiate the atomic sequence on the one or more cache lines, as described above.

As further shown in FIG. 6, process 600 may include monitoring, during the atomic sequence, whether atomicity remains valid for the one or more cache lines (block 630). For example, the storage device may monitor, during the atomic sequence, whether atomicity remains valid for the one or more cache lines, as described above.

As further shown in FIG. 6, process 600 may include selectively completing the atomic sequence based at least in part on the atomicity remaining valid or aborting the atomic sequence based at least in part on the atomicity failing to remain valid (block 640). For example, the storage device may selectively complete the atomic sequence based at least in part on the atomicity remaining valid or abort the atomic sequence based at least in part on the atomicity failing to remain valid, as described above.

Process 600 may include additional implementations, such as any single implementation or any combination of implementations described below and/or in connection with one or more other processes described elsewhere herein.

In a first implementation, completing the atomic sequence comprises modifying the one or more cache lines, and writing back to storage the one or more cache lines after being modified.

In a second implementation, alone or in combination with the first implementation, process 600 includes providing an indication of whether the one or more cache lines were updated in association with the request.

In a third implementation, alone or in combination with one or more of the first and second implementations, process 600 includes providing an indication of whether atomicity remains valid within an entry of a store queue associated with a write operation of the atomic sequence.

In a fourth implementation, alone or in combination with one or more of the first through third implementations, process 600 includes storing information associated with the one or more cache lines and the atomic sequence in a hardware structure configured for monitoring atomic cache lines.

In a fifth implementation, alone or in combination with one or more of the first through fourth implementations, the information comprises one or more of an indication of validity of a cache line of the one or more cache lines, an address of the cache line, or an indication, associated with the cache line, of whether to abort the atomic sequence.

In a sixth implementation, alone or in combination with one or more of the first through fifth implementations, the information comprises atomic monitoring cache lines for respective cache lines of the one or more cache lines.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

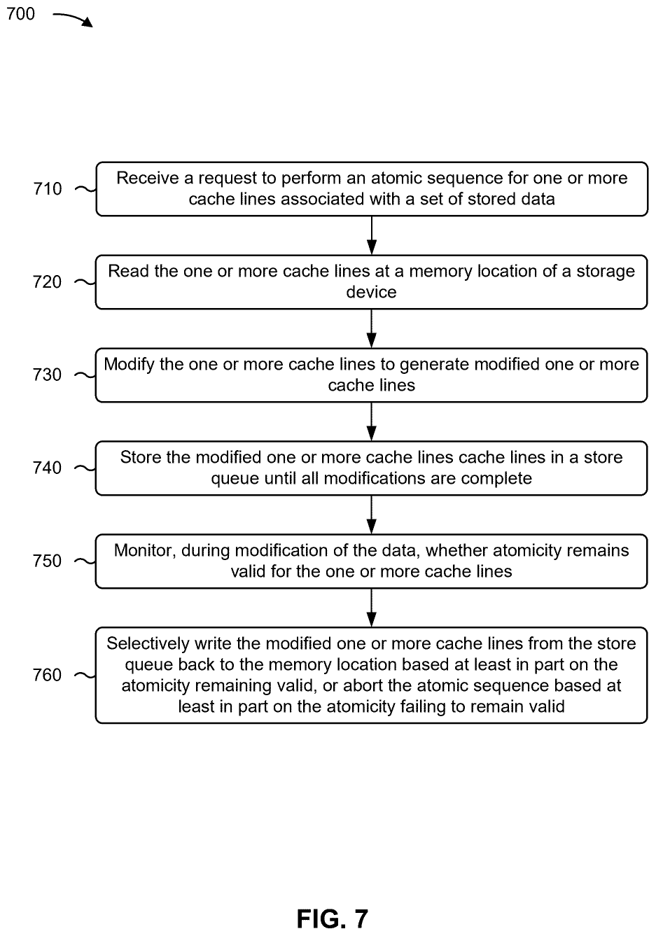

FIG. 7 is a flowchart of an example process 700 associated with atomic sequences using multiple cache lines. In some implementations, one or more process blocks of FIG. 7 may be performed by a storage device (e.g., storage device 104). In some implementations, one or more process blocks of FIG. 7 may be performed by another device or a group of devices separate from or including the storage device. Additionally, or alternatively, one or more process blocks of FIG. 7 may be performed by one or more components of device 400, such as processor 420, memory 430, storage component 440, input component 450, output component 460, and/or communication component 470.

As shown in FIG. 7, process 700 may include receiving a request to perform an atomic sequence for one or more cache lines associated with a set of stored data (block 710). For example, the storage device may receive a request to perform an atomic sequence for one or more cache lines associated with a set of stored data, as described above.

As further shown in FIG. 7, process 700 may include reading the one or more cache lines at a memory location of a storage device (block 720). For example, the storage device may read the one or more cache lines at a memory location of a storage device, as described above.

As further shown in FIG. 7, process 700 may include modifying the one or more cache lines to generate modified one or more cache lines (block 730). For example, the storage device may modify the one or more cache lines to generate modified one or more cache lines, as described above.

As further shown in FIG. 7, process 700 may include storing the modified one or more cache lines in a store queue until all modifications are complete (block 740). For example, the storage device may store the modified one or more cache lines in a store queue until all modifications are complete, as described above.

As further shown in FIG. 7, process 700 may include monitoring, during modification of the data, whether atomicity remains valid for the one or more cache lines (block 750). For example, the storage device may monitor, during modification of the data, whether atomicity remains valid for the one or more cache lines, as described above.

As further shown in FIG. 7, process 700 may include selectively writing the modified one or more cache lines from the store queue back to the memory location based at least in part on the atomicity remaining valid, or aborting the atomic sequence based at least in part on the atomicity failing to remain valid (block 760). For example, the storage device may selectively write the modified one or more cache lines from the store queue back to the memory location based at least in part on the atomicity remaining valid, or abort the atomic sequence based at least in part on the atomicity failing to remain valid, as described above.

Process 700 may include additional implementations, such as any single implementation or any combination of implementations described below and/or in connection with one or more other processes described elsewhere herein.

In a first implementation, writing of the modified one or more cache lines from the store to the memory location is further based at least in part on none of the updated one or more cache lines being associated with an indication to abort the atomic sequence, or wherein aborting of the atomic sequence is further based at least in part on at least one of the updated one or more cache lines being associated with an indication to abort the atomic sequence.

In a second implementation, alone or in combination with the first implementation, process 700 may include storing, within a hardware structure configured for monitoring atomic cache lines, one or more of an indication of validity of a cache line of the one or more cache lines, an address of the cache line, or an indication, associated with the cache line, of whether to abort the atomic sequence.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving from an application programming interface (API), a request to perform an atomic sequence for one or more cache lines associated with a set of stored data;
initiating the atomic sequence on the one or more cache lines;
monitoring, during the atomic sequence, whether atomicity remains valid for the one or more cache lines; and
providing, to the API, an indication of whether the one or more cache lines were updated in association with the request based at least in part on whether the atomicity remained valid.

2. The method of claim 1, further comprising:
updating the one or more cache lines based at least in part on maintaining valid atomicity.

3. The method of claim 1, further comprising:
refraining from updating the one or more cache lines based at least in part on failing to maintain valid atomicity.

4. The method of claim 1, further comprising:
providing an indication of whether atomicity remains valid within an entry of a store queue associated with a write operation of the atomic sequence.

5. The method of claim 1, wherein the atomic sequence comprises:
reading data at a memory location of a storage device;
modifying the data to generate modified data; and
writing back the modified data to the memory location without another device reading or modifying the memory location after the reading of the data at the memory location.

6. The method of claim 5, further comprising:
storing cache lines of the modified data in a store queue; and
refraining from writing back the modified data to the memory location until all of the cache lines of the modified data are stored in the store queue.

7. The method of claim 6, wherein writing back the modified data to the memory location comprises writing back the modified data based at least in part on:
all of the cache lines of the modified data being stored in the store queue;
atomicity remaining valid at a time of writing back the modified data; and
none of the cache lines of the modified data being associated with an indication to abort the atomic sequence.

8. The method of claim 1, further comprising:
storing information associated with the one or more cache lines and the atomic sequence in a hardware structure configured for monitoring atomic cache lines.

9. The method of claim 8, wherein the information comprises one or more of:
an indication of validity of a cache line of the one or more cache lines, an address of the cache line, or
an indication, associated with the cache line, of whether to abort the atomic sequence.

10. The method of claim 8, wherein the information comprises:
atomic monitoring cache lines for respective cache lines of the one or more cache lines.

11. A computer program product comprising:
one or more computer readable storage media, and program instructions collectively stored on the one or more computer readable storage media, the program instructions comprising:
program instructions to receive a request to perform an atomic sequence for one or more cache lines associated with a set of stored data;
program instructions to initiate the atomic sequence on the one or more cache lines;
program instructions to monitor, during the atomic sequence, whether atomicity remains valid for the one or more cache lines; and
program instructions to selectively:
complete the atomic sequence based at least in part on the atomicity remaining valid; or
abort the atomic sequence based at least in part on the atomicity failing to remain valid.

12. The computer program product of claim 11, wherein, to complete the atomic sequence, the program instructions comprise:
program instructions to modify the one or more cache lines; and
program instructions write back to storage the one or more cache lines after being modified.

13. The computer program product of claim 11, wherein the program instructions comprise:
program instructions to provide an indication of whether the one or more cache lines were updated in association with the request.

14. The computer program product of claim 11, wherein the program instructions comprise:
program instructions to provide an indication of whether atomicity remains valid within an entry of a store queue associated with a write operation of the atomic sequence.

15. The computer program product of claim 11, wherein the program instructions comprise:
program instructions to store information associated with the one or more cache lines and the atomic sequence in a hardware structure configured for monitoring atomic cache lines.

16. The computer program product of claim 15, wherein the information comprises one or more of:
an indication of validity of a cache line of the one or more cache lines,
an address of the cache line, or
an indication, associated with the cache line, of whether to abort the atomic sequence.

17. The computer program product of claim 15, wherein the information comprises:
atomic monitoring cache lines for respective cache lines of the one or more cache lines.

18. A system comprising:
one or more devices configured to:
receive a request to perform an atomic sequence for one or more cache lines associated with a set of stored data;
read the one or more cache lines at a memory location of a storage device;
modify the one or more cache lines to generate modified one or more cache lines;
store the modified one or more cache lines in a store queue until all modifications are complete;
monitor, during modification of the data, whether atomicity remains valid for the one or more cache lines; and
selectively:
write the modified one or more cache lines from the store queue back to the memory location based at least in part on the atomicity remaining valid; or
abort the atomic sequence based at least in part on the atomicity failing to remain valid.

19. The system of claim 18, wherein writing of the modified one or more cache lines from the store to the memory location is further based at least in part on none of the updated one or more cache lines being associated with an indication to abort the atomic sequence, or
wherein aborting of the atomic sequence is further based at least in part on at least one of the updated one or more cache lines being associated with an indication to abort the atomic sequence.

20. The system of claim 18, wherein the one or more devices are configured to store, within a hardware structure configured for monitoring atomic cache lines, one or more of:
an indication of validity of a cache line of the one or more cache lines,
an address of the cache line, or
an indication, associated with the cache line, of whether to abort the atomic sequence.
